(19) United States
(12) Patent Application Publication
(10) Pub. No.: US 2017/0055145 A1
(43) Pub. Date: Feb. 23, 2017

(54) DEVICE-BASED FILTERING OF CONTENT ITEMS ASSOCIATED WITH MOBILE APPLICATIONS

(71) Applicant: Google Inc., Mountain View, CA (US)

(72) Inventors: Kavita Kannan, San Francisco, CA (US); Charlie Guo, Mountain View, CA (US); Christopher Kenneth Harris, Santa Clara, CA (US); Xi Mao, Shanghai (CN); Thomas Matthew James Hennigan, London (GB); Sissie Ling-Ie Hsiao, Santa Clara, CA (US); Riccardo Govoni, London (GB); Kotwani Sachin, West New York, NJ (US)

(21) Appl. No.: 15/236,968

(22) Filed: Aug. 15, 2016

Related U.S. Application Data
(63) Continuation of application No. PCT/CN2015/087655, filed on Aug. 20, 2015.

(51) Int. Cl. H04W 8/22; H04L 29/08; H04W 4/00; G06Q 30/08; H04W 4/02; H04W 8/26

(52) U.S. Cl. CPC H04W 8/22; H04W 4/02; H04W 8/26; H04W 4/003; G06Q 30/08; H04L 67/34

(57) ABSTRACT

Implementations described herein relate to filtering content items from a set of eligible content items based on a device filter. A mobile application may be incompatible with one or more devices based on an operating system, an operating system version, hardware configurations of the one or more client devices, etc. To remove incompatible content items, a device filter can be generated by comparing a set of required features for the corresponding mobile application with data from a data structure identifying several known mobile devices and associated sets of features. The set of required features for the mobile application may include a minimum operating system version, one or more eligible countries, and/or one or more features of a mobile device. The device filter can include a set of identifiers for the known mobile devices that are incompatible with the mobile application based on the comparison.

### RELATED APPLICATIONS

This application is the continuation of and claims priority to Application Number PCT/CN2015/087655 filed Aug. 20, 2015 and titled “DEVICE-BASED FILTERING OF CONTENT ITEMS ASSOCIATED WITH MOBILE APPLICATIONS.” The contents of the foregoing application are incorporated herein by reference in its entirety.

### BACKGROUND

In a networked environment, such as the Internet or other networks, first-party content providers can provide information for public presentation on resources, for example webpages, documents, applications, and/or other resources. The first-party content can include text, video, and/or audio information provided by the first-party content providers via, for example, a resource server for presentation on a client device over the Internet. The first-party content may be a webpage requested by the client device or a stand-alone application (e.g., a video game, a chat program, etc.) running on the client device. Additional third-party content can also be provided by third-party content providers for presentation on the client device together with the first-party content provided by the first-party content providers. For example, the third-party content may be a public service announcement or advertisement that appears in conjunction with a requested resource, such as a webpage (e.g., a search result webpage from a search engine, a webpage that includes an online article, a webpage of a social networking service, etc.) or with an application (e.g., an advertisement within a game). Thus, a person viewing a resource can access the first-party content that is the subject of the resource as well as the third-party content that may or may not be related to the subject matter of the resource.

### SUMMARY

Implementations described herein relate to filtering out content items from a set of eligible content items for an auction based on a device filter. A mobile application may be incompatible with one or more client devices based on an operating system, an operating system version, hardware configurations of the one or more client devices, etc. To remove content items based on incompatibility of a corresponding mobile application with a client device, a device filter can be generated by comparing a set of required features for the corresponding mobile application with data from a data structure identifying several known mobile devices and associated sets of features for each of the known mobile devices. In some instances, the set of required features for the mobile application may include a minimum operating system version, one or more eligible countries, and/or one or more features of a mobile device. The device filter can include a set of identifiers for the known mobile devices that are incompatible with the mobile application based on the comparison and can be used to filter out content items based on data identifying a set of device features for a requesting mobile device or an identifier for the mobile device.

One implementation relates to a method that includes accessing a set of required features for a mobile application and accessing a data structure identifying a set of known mobile devices each associated with a set of features. The method also includes generating a device filter based on a comparison of the set of required features to the associated set of features of the data structure for each of the set of known mobile devices of the data structure. The device filter includes a set of identifiers for one or more of the set of known mobile devices that are incompatible with the mobile application based on the comparison. The method further includes receiving a request for a content item from a mobile device. The request includes data identifying a set of device features or an identifier for the mobile device. The method also includes filtering out a first content item associated with the mobile application from a set of eligible content items for a content item auction based on the generated device filter and the data identifying the set of device features or the identifier for the mobile device of the request. The method further includes selecting a second content item from the filtered set of eligible content items via the content item auction and serving the selected second content item to the mobile device responsive to the received request.

Another implementation relates to a system that includes one or more processors and one or more storage devices. The one or more storage devices includes instructions that cause the one or more processors to perform several operations. The operations include accessing a set of required features for each of a set of mobile applications and accessing a data structure identifying a set of known mobile devices each associated with a set of features. The set of required features includes a minimum operating system version. The operations also include generating a device filter based on a comparison of the set of required features for each of the set of mobile applications to the associated set of features of the data structure for each of the set of known mobile devices of the data structure. The device filter includes a set of identifiers for one or more of the set of known mobile devices that are incompatible with one of the set of mobile applications. The operations further include receiving a request for a content item from a mobile device. The request includes data identifying a set of device features or an identifier for the mobile device. The operations include filtering out a first content item associated with a first mobile application of the set of mobile applications from a set of eligible content items for a content item auction based on a comparison of the minimum operating system version of the set of required features to an operating system version of the set of device features or an operating system version associated with the identifier for the mobile device. The operations also include filtering out a second content item associated with a second mobile application of the set of mobile applications from a remaining set of eligible content items for a content item auction based on the generated device filter and the data identifying the set of device features or the identifier for the mobile device of the request. The operations further include selecting a third content item from the filtered remaining set of eligible content items via the content item auction and serving the selected third content item to the mobile device responsive to the received request.

Yet a further implementation relates to a computer readable storage device storing instructions that, when executed by one or more processors, cause the one or more processors to perform several operations. The operations include accessing a set of required features from an application store for a mobile application and accessing a data structure identifying a set of known mobile devices each associated with a set of features. The operations also include generating a device filter based on a comparison of the set of required features to the associated set of features of the data structure for each of the set of known mobile devices of the data structure. The device filter includes a set of identifiers for one or more of the set of known mobile devices that are incompatible with the mobile application based on the comparison. The operations further include receiving a request for a content item from a mobile device. The request includes data identifying a set of device features or an identifier for the mobile device. The operations also include filtering out a first content item associated with the mobile application from a set of eligible content items for a content item auction based on the generated device filter and the data identifying the set of device features or the identifier for the mobile device of the request. The operations further include selecting a second content item from the filtered set of eligible content items via the content item auction and serving the selected second content item to the mobile device responsive to the received request.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is an overview depicting an implementation of a system of providing information via a computer network;

FIG. 2 is an illustration of an implementation of a first-party resource displayed on a display of a mobile client device and having third-party content;

FIG. 3 is a block diagram of an implementation of a system for device-based filtering of content items associated with mobile applications;

FIG. 4 is a flow diagram of an implementation of a process for generating a device-based filter for a content item selection system;

FIG. 5 is a flow diagram of an implementation of a process for filtering content items using the device-based filter; and

FIG. 6 is a block diagram depicting a general architecture for a computer system that may be employed to implement various elements of the systems and methods described and illustrated herein.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Following below are more detailed descriptions of various concepts related to, and implementations of, methods, apparatuses, and systems for providing information on a computer network. The various concepts introduced above and discussed in greater detail below may be implemented in any of numerous ways as the described concepts are not limited to any particular manner of implementation. Examples of specific implementations and applications are provided primarily for illustrative purposes.

### I. Overview

A computing device (e.g., a client device) can view a resource, such as a webpage, a document, an application, etc. In some implementations, the computing device may access the resource via the Internet by communicating with a server, such as a webpage server, corresponding to that resource. The resource includes first-party content that is the subject of the resource from a first-party content provider and may also include additional third-party provided content, such as advertisements or other content. In one implementation, responsive to receiving a request to access a webpage, a webpage server and/or a client device can communicate with a data processing system, such as a content item selection system, to request a content item to be presented with the requested webpage, such as through the execution of code of the resource to request a third-party content item to be presented with the resource. The content item selection system can select a third-party content item and provide data to effect presentation of the content item with the requested webpage on a display of the client device. In some instances, the content item is selected and served with a resource associated with a search query response. For example, a search engine may return search results on a search results webpage and may include third-party content items related to the search query in one or more content item slots of the search results webpage.

The third-party content item may include a link that, when the third-party content item is interacted with, such as clicking on the content item, directs the computing device to retrieve and/or transmit data to the address indicated by the link. For instance, some content items may have a link to a webpage of the third-party of the third-party content item, a link to an application store or website to install an application of the third-party, and/or a link to the content item selection system to transmit data to the content item selection system, which then redirects the computing device to a subsequent destination, such as the webpage of the third-party of the third-party content item.

The computing device (e.g., a client device) may also be used to view or execute an application, such as a mobile application. The application may include first-party content that is the subject of the application from a first-party content provider and may also include additional third-party provided content, such as advertisements or other content. In one implementation, responsive to use of the application, a resource server and/or a client device can communicate with a data processing system, such as a content item selection system, to request a content item to be presented with a user interface of the application and/or otherwise. The content item selection system can select a third-party content item and provide data to effect presentation of the content item with the application on a display of the client device.

In some instances, a device identifier may be associated with the client device. The device identifier may be a randomized number associated with the client device to identify the device during subsequent requests for resources and/or content items. In some instances, the device identifier may be configured to store and/or cause the client device to transmit information related to the client device to the content item selection system and/or resource server (e.g., values of sensor data, a web browser type, an operating system, historical resource requests, historical content item requests, etc.).

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

In some implementations, the device identifier may be a universally unique device identifier (UDID), such as an identifier for advertisers (IDFA) or an AdID. In other implementations, the device identifier may be an identifier associated with hardware and/or software characteristics of the device, such as a mobile equipment identifier (MEID), international mobile equipment identifier (IMEI), integrated circuit card identifier (ICCID), device serial number, an identifier generated based on hardware and/or software characteristics of the device (e.g., an identifier based, at least in part, on an operating system version, device model, firmware version(s), installed application(s), memory capacity, and/or storage space), etc. Such a device identifier may be used as the cookie or other identifier when interacting with content items.

A third-party content provider, when providing third-party content items for presentation with requested resources via the Internet or other network, may utilize a content item management service to control or otherwise influence the selection and serving of the third-party content items. For instance, a third-party content provider may specify selection criteria (such as keywords) and corresponding bid values that are used in the selection of the third-party content items. The bid values may be utilized by the content item selection system in an auction to select and serve content items for presentation with a resource. For example, a third-party content provider may place a bid in the auction that corresponds to an agreement to pay a certain amount of money if a user interacts with the provider's content item (e.g., the provider agrees to pay $3 if a user clicks on the provider's content item). In other examples, a third-party content provider may place a bid in the auction that corresponds to an agreement to pay a certain amount of money if the content item is selected and served (e.g., the provider agrees to pay $0.005 each time a content item is selected and served or the provider agrees to pay $0.05 each time a content item is selected or clicked). In some instances, the content item selection system uses content item interaction data to determine the performance of the third-party content provider's content items. For example, users may be more inclined to click on third-party content items on certain webpages over others. Accordingly, auction bids to place the third-party content items may be higher for high-performing webpages, categories of webpages, and/or other criteria, while the bids may be lower for low-performing webpages, categories of webpages, and/or other criteria.

In some instances, one or more performance metrics for the third-party content items may be determined and indications of such performance metrics may be provided to the third-party content provider via a user interface for the content item management account. For example, the performance metrics may include a cost per impression (CPI) or cost per thousand impressions (CPM), where an impression may be counted, for example, whenever a content item is selected to be served for presentation with a resource. In some instances, the performance metric may include a click-through rate (CTR), defined as the number of clicks on the content item divided by the number of impressions. Still other performance metrics, such as cost per action (CPA) (where an action may be clicking on the content item or a link therein, a purchase of a product, a referral of the content item, etc.), conversion rate (CVR), cost per click-through (CPC) (counted when a content item is clicked), cost per sale (CPS), cost per lead (CPL), effective CPM (eCPM), and/or other performance metrics may be used.

In some instances, a webpage or other resource (such as, for example, an application) includes one or more content item slots in which a selected and served third-party content item may be displayed. The code (e.g., JavaScript®, HTML, etc.) defining a content item slot for a webpage or other resource may include instructions to request a third-party content item from the content item selection system to be presented with the webpage. In some implementations, the code may include an image request having a content item request URL that may include one or more parameters (e.g., /page/contentitem?devid=abc123&devnfo=A34r0). Such parameters may, in some implementations, be encoded strings such as “devid=abc123” and/or “devnfo=A34r0.”

The selection of a third-party content item to be served with the resource by a content item selection system may be based on several influencing factors, such as a predicted click through rate (pCTR), a predicted conversion rate (pCVR), a bid associated with the content item, etc. Such influencing factors may be used to generate a value, such as a score, against which other scores for other content items may be compared by the content item selection system through an auction.

During an auction for a content item slot for a resource, such as a webpage, several different types of bid values may be utilized by third-party content providers for various third-party content items. For example, an auction may include bids based on whether a user clicks on the third-party content item, whether a user performs a specific action based on the presentation of the third-party content item, whether the third-party content item is selected and served, and/or other types of bids. For example, a bid based on whether the third-party content item is selected and served may be a lower bid (e.g., $0.005) while a bid based on whether a user performs a specific action may be a higher bid (e.g., $5). In some instances, the bid may be adjusted to account for a probability associated with the type of bid and/or adjusted for other reasons. For example, the probability of the user performing the specific action may be low, such as 0.2%, while the probability of the selected and served third-party content item may be 100% (e.g., the selected and served content item will occur if it is selected during the auction, so the bid is unadjusted). Accordingly, a value, such as a score or an normalized value, may be generated to be used in the auction based on the bid value and the probability or another modifying value. In the prior example, the value or score for a bid based on whether the third-party content item is selected and served may be $0.005*1.00=0.005 and the value or score for a bid based on whether a user performs a specific action may be $5*0.002=0.01. To maximize the income generated, the content item selection system may select the third-party content item with the highest value from the auction. In the foregoing example, the content item selection system may select the content item associated with the bid based on whether the user performs the specific action due to the higher value or score associated with that bid.

Once a third-party content item is selected by the content item selection system, data to effect presentation of the third-party content item on a display of the client device may be provided to the client device using a network.

In some instances, a content item may be associated with a mobile application for a client device. The content item may be a click-to-download type content item (e.g., having a link to a landing page to download the mobile application and/or to a landing page of an application store of the mobile application). With the wide variety of client devices available to consumers, certain mobile applications may be incompatible with one or more client devices. For instance, a mobile application may be incompatible with one or more client devices based on an operating system, an operating system version, hardware configurations of the one or more client devices, etc. If a client device is incompatible with the mobile application associated with the content item, then it may be less useful to select and serve the content item to that client device. Moreover, it may reduce latency to remove content items associated with mobile applications that are incompatible for the client device prior to performing an auction of the eligible content items. That is, the removal of content items based on incompatibility with the requesting client device can reduce the number of eligible content items in the auction, thereby increase the speed with which a content item selection system may select and serve a content item responsive to a request from the client device.

To remove content items based on incompatibility of a corresponding mobile application with a client device, a device filter can be generated by comparing a set of required features for the corresponding mobile application with data from a data structure identifying several known mobile devices and associated sets of features for each of the known mobile devices. In some instances, the set of required features for the mobile application may include a minimum operating system version, one or more eligible countries, and/or one or more features of a mobile device. The device filter can include a set of identifiers for the known mobile devices that are incompatible with the mobile application based on the comparison and can be used to filter out content items based on data identifying a set of device features for a requesting mobile device or an identifier for the mobile device.

The device filter can thus proactively identify mobile devices that are incapable of converting for the content item (e.g., installing a corresponding mobile application) rather than only reactively identifying mobile devices based on machine learning. Moreover, the proactive identification of mobile devices that cannot convert for a content item can improve the speed of machine learning models based on eliminating the additional data that would have been generated by serving a content item to an incompatible device.

While the foregoing has provided an overview of filtering content items from sets of eligible content items based on client device incompatibility with a mobile application associated with the content item, more specific implementations and systems to implement such a system will now be described.

### II. Overview of an Implementation of a System for Selecting and Serving Content Items

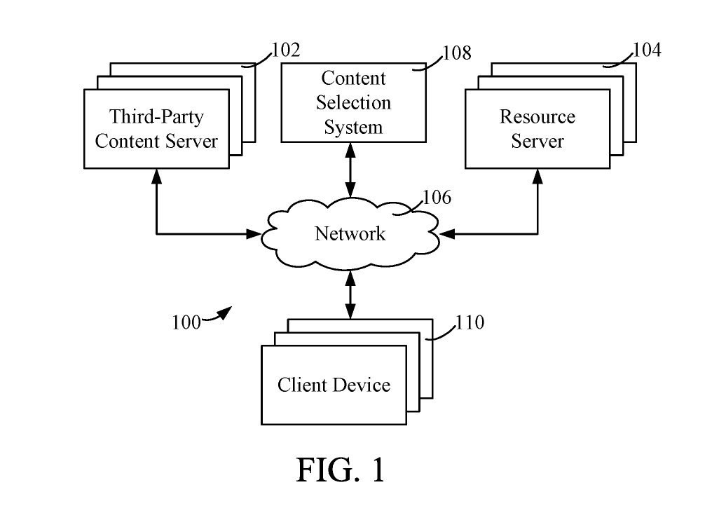

FIG. 1 is a block diagram of an implementation of a system 100 for providing information via at least one computer network such as the network 106. The network 106 may include a local area network (LAN), wide area network (WAN), a telephone network, such as the Public Switched Telephone Network (PSTN), a wireless link, an intranet, the Internet, or combinations thereof. The system 100 can also include at least one data processing system, such as a content item selection system 108. The content item selection system 108 can include at least one logic device, such as a computing device having a data processor, to communicate via the network 106, for example with a resource server 104, a client device 110, and/or a third-party content server 102. The content item selection system 108 can include one or more data processors, such as a content placement processor, configured to execute instructions stored in a memory device to perform one or more operations described herein. In other words, the one or more data processors and the memory device of the content item selection system 108 may form a processing module. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, ActionScript®, C, C++, C#, Java®, JavaScript®, JSON, Perl®, HTML, HTML5, XML, Python®, and Visual Basic®. The processor may process instructions and output data to effect presentation of one or more content items to the resource server 104 and/or the client device 110. In addition to the processing circuit, the content item selection system 108 may include one or more databases configured to store data. The content item selection system 108 may also include an interface configured to receive data via the network 106 and to provide data from the content item selection system 108 to any of the other devices on the network 106. The content item selection system 108 can include a server, such as an advertisement server or otherwise.

The client device 110 can include one or more devices such as a computer, laptop, desktop, smart phone, tablet, personal digital assistant, set-top box for a television set, a smart television, or server device configured to communicate with other devices via the network 106. The device may be any form of portable electronic device that includes a data processor and a memory. The memory may store machine instructions that, when executed by a processor, cause the processor to perform one or more of the operations described herein. The memory may also store data to effect presentation of one or more resources, content items, etc. on the computing device. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, ActionScript®, C, C++, C#, HTML, Java®, JavaScript®, Perl®, Python®, Visual Basic®, and XML.

The client device 110 can execute a software application (e.g., a web browser or other application) to retrieve content from other computing devices over network 106. Such an application may be configured to retrieve first-party content from a resource server 104. In some cases, an application running on the client device 110 may itself be first-party content (e.g., a game, a media player, etc.). In one implementation, the client device 110 may execute a web browser application which provides a browser window on a display of the client device. The web browser application that provides the browser window may operate by receiving input of a uniform resource locator (URL), such as a web address, from an input device (e.g., a pointing device, a keyboard, a touch screen, or another form of input device). In response, one or more processors of the client device executing the instructions from the web browser application may request data from another device connected to the network 106 referred to by the URL address (e.g., a resource server 104). The other device may then provide web page data and/or other data to the client device 110, which causes visual indicia to be displayed by the display of the client device 110. Accordingly, the browser window displays the retrieved first-party content, such as web pages from various websites, to facilitate user interaction with the first-party content.

The resource server 104 can include a computing device, such as a server, configured to host a resource, such as a web page or other resource (e.g., articles, comment threads, music, video, graphics, search results, information feeds, etc.). The resource server 104 may be a computer server (e.g., a file transfer protocol (FTP) server, file sharing server, web server, etc.) or a combination of servers (e.g., a data center, a cloud computing platform, etc.). The resource server 104 can provide resource data or other content (e.g., text documents, PDF files, and other forms of electronic documents) to the client device 110. In one implementation, the client device 110 can access the resource server 104 via the network 106 to request data to effect presentation of a resource of the resource server 104.

One or more third-party content providers may have third-party content servers 102 to directly or indirectly provide data for third-party content items to the content item selection system 108 and/or to other computing devices via network 106. The content items may be in any format that may be presented on a display of a client device 110, for example, graphical, text, image, audio, video, etc. The content items may also be a combination (hybrid) of the formats. The content items may be banner content items, interstitial content items, pop-up content items, rich media content items, hybrid content items, Flash® content items, cross-domain iframe content items, etc. The content items may also include embedded information such as hyperlinks, metadata, links, machine-executable instructions, annotations, etc. In some instances, the third-party content servers 102 may be integrated into the content item selection system 108 and/or the data for the third-party content items may be stored in a database of the content item selection system 108.

In one implementation, the content item selection system 108 can receive, via the network 106, a request for a content item to present with a resource. The received request may be received from a resource server 104, a client device 110, and/or any other computing device. The resource server 104 may be owned or ran by a first-party content provider that may include instructions for the content item selection system 108 to provide third-party content items with one or more resources of the first-party content provider on the resource server 104. In one implementation, the resource may include a web page. The client device 110 may be a computing device operated by a user (represented by a device identifier), which, when accessing a resource of the resource server 104, can make a request to the content item selection system 108 for content items to be presented with the resource, for instance. The content item request can include requesting device information (e.g., a web browser type, an operating system type, one or more previous resource requests from the requesting device, one or more previous content items received by the requesting device, a language setting for the requesting device, a geographical location of the requesting device, a time of a day at the requesting device, a day of a week at the requesting device, a day of a month at the requesting device, a day of a year at the requesting device, etc.) and resource information (e.g., URL of the requested resource, one or more keywords of the content of the requested resource, text of the content of the resource, a title of the resource, a category of the resource, a type of the resource, etc.). The information that the content item selection system 108 receives can include a HyperText Transfer Protocol (HTTP) cookie which contains a device identifier (e.g., a random number) that represents the client device 110. In some implementations, the device information and/or the resource information may be appended to a content item request URL (e.g., contentitem.item/page/contentitem?devid=abc123&devnfo=A34r0). In some implementations, the device information and/or the resource information may be encoded prior to being appended the content item request URL. The requesting device information and/or the resource information may be utilized by the content item selection system 108 to select third-party content items to be served with the requested resource and presented on a display of a client device 110.

In some instances, a resource of a resource server 104 may include a search engine feature. The search engine feature may receive a search query (e.g., a string of text) via an input feature (an input text box, etc.). The search engine may search an index of documents (e.g., other resources, such as web pages, etc.) for relevant search results based on the search query. The search results may be transmitted as a second resource to present the relevant search results, such as a search result web page, on a display of a client device 110. The search results may include web page titles, hyperlinks, etc. One or more third-party content items may also be presented with the search results in a content item slot of the search result web page. Accordingly, the resource server 104 and/or the client device 110 may request one or more content items from the content item selection system 108 to be presented in the content item slot of the search result web page. The content item request may include additional information, such as the user device information, the resource information, a quantity of content items, a format for the content items, the search query string, keywords of the search query string, information related to the query (e.g., geographic location information and/or temporal information), etc. In some implementations, a delineation may be made between the search results and the third-party content items to avert confusion.

In some implementations, the third-party content provider may manage the selection and serving of content items by content item selection system 108. For example, the third-party content provider may set bid values and/or selection criteria via a user interface that may include one or more content item conditions or constraints regarding the serving of content items. A third-party content provider may specify that a content item and/or a set of content items should be selected and served for user devices 110 having device identifiers associated with a certain geographic location or region, a certain language, a certain operating system, a certain web browser, etc. In another implementation, the third-party content provider may specify that a content item or set of content items should be selected and served when the resource, such as a web page, document, etc., contains content that matches or is related to certain keywords, phrases, etc. The third-party content provider may set a single bid value for several content items, set bid values for subsets of content items, and/or set bid values for each content item. The third-party content provider may also set the types of bid values, such as bids based on whether a user clicks on the third-party content item, whether a user performs a specific action based on the presentation of the third-party content item, whether the third-party content item is selected and served, and/or other types of bids.

### III. Implementation of a System for Device-Based Filtering of Content Items

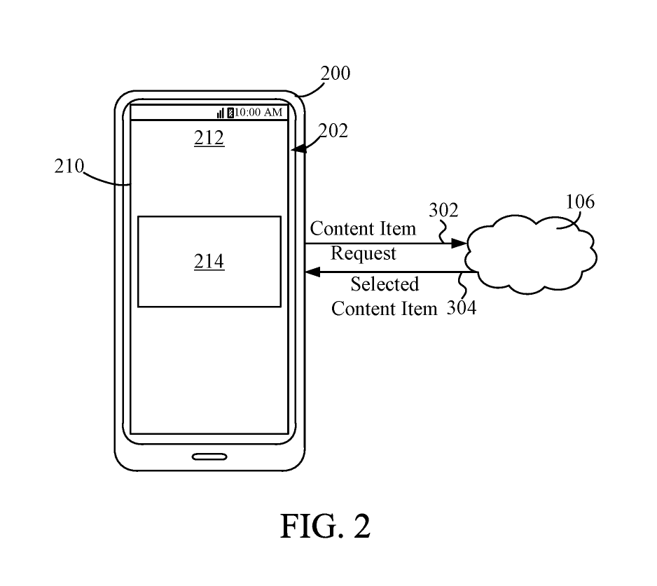

While the foregoing has provided an overview of a system 100 for selecting and serving content items to client devices 110, implementations of systems for filtering, selecting, and serving content items for a client device using a device-based filter will be described in greater detail in reference to FIGS. 2-5.

FIG. 2 depicts a mobile client device 200, such as a smartphone or tablet, on which a resource 210 may be displayed by a display 202 of the client device 200. The resource 210 can be a webpage displayed via a mobile web browser executing on the client device 200 or the resource 210 can be an application executing on the client device 200. In some implementations, the client device 200 may execute code for the resource 210 to display first-party content 212 (e.g., a webpage, website, or application content) on the display 202 of the client device 200 via the mobile web browser. In some implementations, the resource 210 may also include code to request one or more third-party content items 214 to be presented with the first-party content 212. In response, one or more processors of the client device 200 executing the instructions may request data 302 from another device (e.g., a content item selection system 108) connected to a network, such as network 106. The other device may then provide data 304 to display the third-party content item 214 to the client device 200, which causes visual indicia to be displayed by the display 202 of the client device 200.

In some instances, a user of the client device 200 may interact with the third-party content item 214. The interaction with the third-party content item 214 may include a link associated with the third-party content item 214. The link may be a link to a third-party resource, such as a webpage associated with the third-party content item 214 or a main webpage for the third-party of the third-party content item 214, or the link may be to a landing page for downloading an executable file for a mobile application, such as a link to a landing page for a mobile application from an application store or a separate website. Upon interaction with the third-party content item 214, the mobile web browser may retrieve data for the webpage of the link, retrieve a landing page for downloading an executable file for a mobile application, or download the executable file for the mobile application.

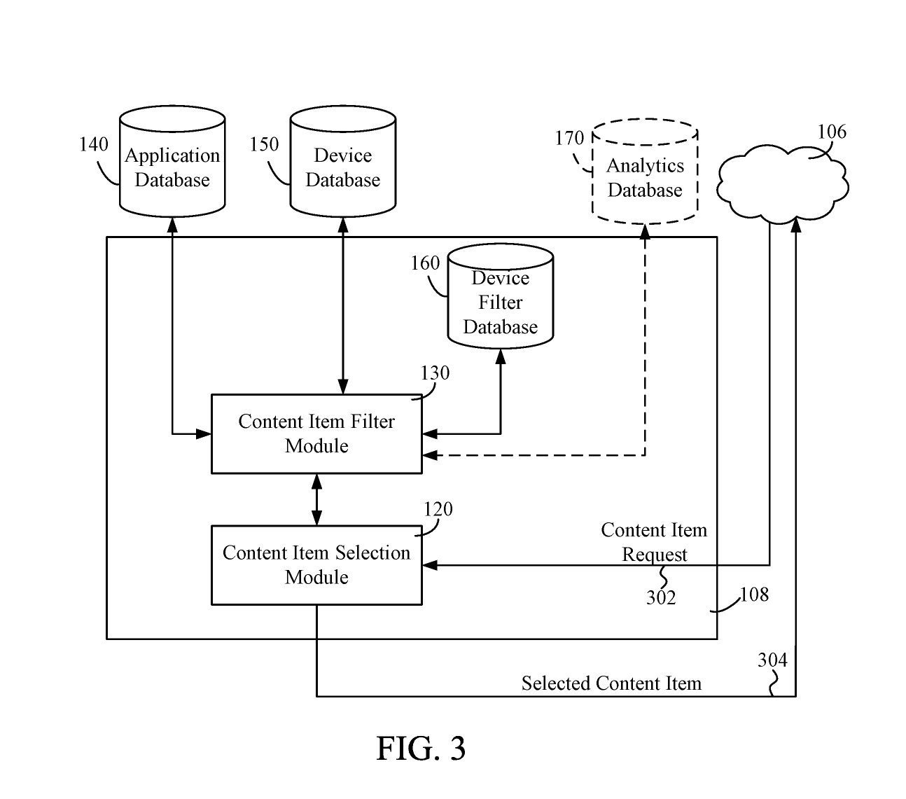

FIG. 3 depicts a block diagram of an implementation of an implementation of a portion of the content item selection system 108 of FIG. 1 that includes a content item selection module 120 and a content item filter module 130 for device-based filtering of content items associated with mobile applications. The content item selection system 108 also includes one or more databases, such as an application database 140, a device database 150, a device filter database 160, and/or an analytics database 170.

The databases 140, 150, 160, 170 may store data for and/or provide data to the content item filter module 130. The databases 140, 150, 160, 170 may include a static storage device, such as ROM, solid state drive (SSD), flash memory (e.g., EEPROM, EPROM, etc.), magnetic disc, optical disc, etc., a plurality of static storage devices, a cloud storage system, a server, and/or any other electronic device capable of storing and providing data. While the implementation shown in FIG. 3 depicts the databases 140, 150, 160, 170 as separate databases, it should be understood that the databases 140, 150, 160, 170 may be combined into a single database or sets of databases.

The content item selection module 120 is configured to receive a content item request 302 via the network 106. A client device, such as client device 110 of FIG. 1 or client device 200 of FIG. 2, or a resource server, such as resource server 104, may send the content item request 302 to the content item selection system 108 via the network 106. The content item request 302 may include one or more parameters representative of characteristics of the client device (e.g., a unique identifier associated with the client device, a type of client device, a display type of a client device, dimensions of the display, etc.) and/or characteristics of a resource with which the content item is to be presented (e.g., a URL of the resource, one or more keywords of the content of the resource, text of the content of the resource, a title of the resource, a category of the resource, a type of the resource, a property of the resource, an interactivity level of the resource, a ranking of the resource, a popularity of the resource, a category of a publisher associated with the resource, a type of a publisher associated with the resource, a property of a publisher associated with the resource, etc.). In some implementations, the foregoing parameters may be appended to or included in a content item request URL (e.g., /page/contentitem?devid=abc123&devnfo=A34r0).

Responsive to the content item request 302, the content item selection module 120 is configured to select and serve a content item 304. In some implementations, the content item selection module 120 is configured to perform an auction. That is, the content item selection module 120 may generate one or more values, such as scores, for one or more content items based, at least in part, on the content item request 302, and select one or more content items to be served. In some instances, the content item selection module 120 ranks the values (e.g., highest to lowest) and selects the content item associated with a value based on the ranking (e.g., selecting the content item associated with the highest ranked value or score).

Data to display the selected content item 304 may be transmitted or served by the content item selection module 120 to the client device and/or the resource server via the network 106. The data can include graphical data, textual data, image data, audio data, video data, etc. that may be accessed from a database.

In some implementations, a content item filter module 130 may filter content items from a set of eligible content items for the auction to be performed by the content item selection module 120. The content item filter module 130 removes content items from a set of eligible content items based on whether the requesting device can install an application associated with a content item. That is, if a client device, such as client device 200 of FIG. 2, is unable to install the application associated with the content item, then the content item filter module 130 removes the content item from the set of eligible content items such that the content item selection module 120 does not even consider the removed content items when performing the auction.

The content item filter module 130 filters content items from the set of eligible content items based on one or more device filters. The one or more device filters can be stored and/or accessed from the device filter database 160. The device filters may include a set or list of tuples. The tuples can include a first unique identifier associated with an application and a second unique identifier identifying a corresponding known mobile device that is incompatible with the application, such as <AppinID, DeviceID>. In some instances, the tuples can further include a third unique identifier identifying a minimum operating system version for the application. In some instances, several known mobile devices can be associated with a single unique identifier when the several known mobile devices have similar features, similar operating system versions, etc. In some instances, each unique identifier identifying a corresponding known mobile device may be based on a device model, a device manufacturer, a device brand, and/or device features.

The content item request 302 received by the content item selection system 108 may include data identifying a set of device features or an identifier for the mobile device. In some implementations, the content item filter module 130 can use the identifier for the mobile device (e.g., an IMEI, an ESN, a MEID, etc.) to determine the unique identifier for the corresponding known mobile device. In some instances, the identifier for the mobile device may correspond to a device model, manufacturer, and/or brand that may be used to determine the unique identifier for the corresponding known mobile device. In other implementations, the content item filter module 130 may compare the data identifying the set of device features to a set of known devices from the device database 150 to determine the unique identifier for the corresponding known mobile device.

Once the unique identifier for the corresponding known mobile device is determined, the content item filter module 130 can compare the unique identifier for the corresponding known mobile device to the identifiers of the tuples stored in the device filter database 160 to determine a set of identifiers associated with applications which are incompatible with the known mobile device sending the request. A content item associated with an application can include data associating the content item with the application, such as metadata for the unique identifier of the associated application. The content item filter module 130 compares the set of eligible content items for the auction to the set of identifiers associated with incompatible applications and filters out one or more content items from the set of eligible content items based on the comparison. The remaining or filtered set of content items can then be sent to the content item selection module 120 for the auction. The content item selection module 120 selects a content item from the filtered set of eligible content items via the content item auction and serves the selected content item 304 to the known mobile device responsive to the request.

The content item filter module 130 may also generate the one or more content item filters of the device filter database 160. To generate a tuple of the one or more content item filters, the content item filter module 130 accesses a set of required features for an application from an application database 140. In some instances, the application database 140 may be a local database or the application database 140 may be a remote database relative to the content item filter module 130. In some instances, the application database 140 may be an application store. In some implementations, the application store is controlled by a separate entity from the entity performing the content item auction. The set of required features may be retrieved using an API to interact with the application store. In other implementations, the set of required features may be accessed via information from a landing page for the application of the application store. The set of required features may include one or more hardware features (e.g., a camera, a particular camera magnification level, near-field communication, etc.), one or more software features (e.g., other applications, plugins, etc.), an operating system type, a minimum operating system version, a list or set of eligible counties, etc.

The content item filter module 130 also accesses a data structure identifying one or more known mobile devices that are each associated with a set of features. The data structure may be a table or other data structure that includes a unique identifier for each of the known mobile devices (or for a set of similar mobile devices) and data indicative of a set of features or other data for the known mobile devices. For instance, the set of features can include one or more hardware features, one or more software features, an operating system type, an operating system version, a mobile carrier, a model name, a manufacturer, etc. The set of features of the data structure may be provided by one or more device manufacturers and/or retrieved from another database.

Using the accessed set of required features for an application and the set of features of the data structure for the one or more known mobile devices, the content item filter 130 generates a device filter by comparing the set of required features to each of the associated set of features for each of the known mobile devices. That is, if the set features for each of the known mobile devices does not match or exceed those of the set of required features for the application, then the unique identifier for the known mobile device (or set of mobile devices) is added to the device filter (e.g., by adding a tuple of the application identifier and the device identifier). If the set features for a known mobile device does match or exceed those of the set of required features for the application, then the unique identifier for the known mobile device is not included in the device filter.

In some implementations, the content item filter 130 stores the generated device filter in the device filter database 160 to be retrieved when a content item request 302 is received from a client device and/or when a content item associated with an application is part of the set of eligible content items.

In some implementations, an analytics database 170 may also be accessed by the content item filter 130. The analytics database 170 may contain data indicative of impressions of one or more content items and conversions for the one or more content items. For content items associated with an application that is the subject of one or more of the device filters, the content item filter 130 may access the analytics database 170 to determine a number of conversions (e.g., downloads and/or installations) corresponding to one or more of the known mobile devices that were included in the device filter. If the number of conversions is greater than a predetermined number (e.g., 10), then the identifier for the known mobile device may be removed from the device filter. Thus, the analytics data may be used to check whether a filtered device is incompatible with the application or not based on whether a predetermined number of conversion have occurred.

In some implementations, the content item filter 130 may also filter content items based on a minimum operating system version a location associated with the requesting device, and/or a carrier of the requesting device. For instance, the content item filter 130 can filter out a content item associated with a mobile application from a set of eligible content items based on a comparison of the minimum operating system version of the set of required features for the mobile application to an operating system version of a set of device features received from a requesting device and/or an operating system version associated with the identifier for a requesting device. In some implementations, the content item filter 130 may generate a separate minimum operating system version device filter by comparing the minimum operating system version of an application to a minimum operating system version for each of the known mobile devices. The minimum operating system version device filter can be stored in the device filter database 160 to be retrieved when a content item request 302 is received from a client device and/or when a content item associated with an application is part of the set of eligible content items.

The content item filter 130 can filter out a content item associated with a mobile application from a set of eligible content items based on a comparison of a set of eligible countries (or, in some instances, a set of ineligible countries) for the mobile application to data identifying a location received from a requesting device and/or data identifying the mobile carrier for a requesting device. The data identifying the carrier can be indicative of a home location of the mobile device (e.g., Verizon® is indicative of a mobile device having a home location in the United States, O2 is indicative of a mobile device having a home location in the United Kingdom, etc.).

In some implementations, when a content item request 302 is received from a client device, the content item filter 130 may initially filter out content items for which the requesting client device does not meet the minimum operating system version requirement. For instance, the content item filter 130 can compare a minimum operating system version of a set of required features for a mobile application to an operating system version of a set of device features received from a requesting device and/or an operating system version associated with the identifier for a requesting device. In some implementations, the content item filter 130 may retrieve and use a minimum operating system version device filter from the device filter database 160 to filter out content items from the set of eligible content items based on a minimum operating system version.

The content item filter 130 may then filter out content items from the remaining set of eligible content items for which the requesting client device does not meet the set of eligible countries. The content item filter 130 compares a set of eligible countries (or, in some instances, a set of ineligible countries) for a mobile application to data identifying a location received from the requesting device and/or data identifying the mobile carrier for the requesting device.

Finally, the content item filter 130 may filter out content items from the remaining set of eligible content items based on one or more device filters. That is, the content item filter 130 can use an identifier for a requesting device (e.g., an IMEI, an ESN, a MEID, etc.) to determine the unique identifier for a corresponding known mobile device. In some instances, the identifier for a requesting device may correspond to a device model, manufacturer, and/or brand that may be used to determine a unique identifier for the corresponding known mobile device. In other implementations, the content item filter module 130 compares data identifying a set of device features to a set of known devices from the device database 150 to determine the unique identifier for the corresponding known mobile device. Once the unique identifier for the corresponding known mobile device for the requesting device is determined, the content item filter module 130 compares the unique identifier for the corresponding known mobile device to the identifiers of the tuples stored in the device filter database 160 to determine a set of identifiers associated with applications which are incompatible with the known mobile device sending the request. Any content items associated with the set of identifiers associated with incompatible applications are then filtered out of the remaining set of eligible content items.

The resulting set of remaining eligible content items (or identifiers for such content items, such as a unique content item ID) are then sent to the content item selection module 120. Responsive to the content item request 302, the content item selection module 120 selects and serves a content item 304, such as via performing an auction. That is, the content item selection module 120 generates one or more values, such as scores, for one or more content items of the remaining set of eligible content items based, at least in part, on the content item request 302, and selects one or more content items to be served. In some instances, the content item selection module 120 ranks the values (e.g., highest to lowest) and selects the content item associated with a value based on the ranking (e.g., selecting the content item associated with the highest ranked value or score).

Data to display the selected content item 304 is transmitted or served by the content item selection module 120 to the requesting device and/or the resource server via the network 106. The data can include graphical data, textual data, image data, audio data, video data, etc. that may be accessed from a database.

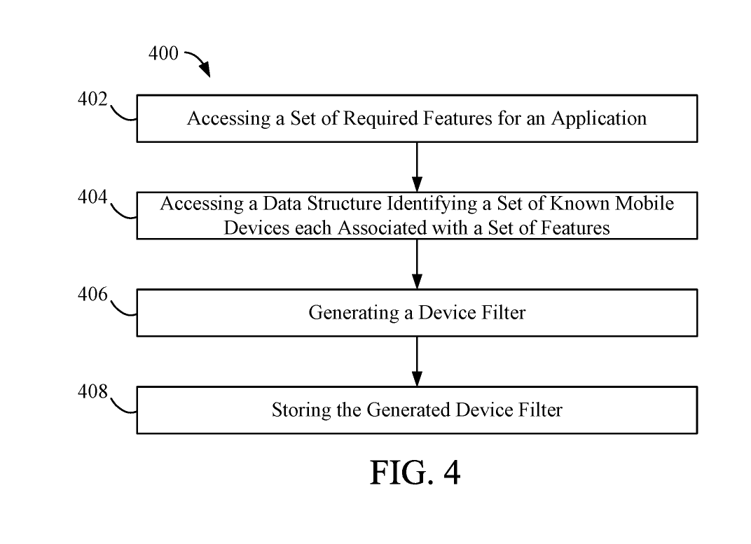

FIG. 4 depicts an example process 400 that may be implemented by the content item selection system to generate a device filter. The process 400 includes accessing a set of required features for an application (block 402). The set of required features can be accessed from an application database. In some instances, the application database may be a local database or the application database may be a remote database relative to the content item selection system. In some instances, the application database may be an application store. In some implementations, the application store is controlled by a separate entity from the content item selection system performing a content item auction. The set of required features may be retrieved using an API to interact with the application store. In other implementations, the set of required features may be accessed via information from a landing page for the application of the application store. The set of required features may include one or more hardware features (e.g., a camera, a particular camera magnification level, near-field communication, etc.), one or more software features (e.g., other applications, plugins, etc.), an operating system type, a minimum operating system version, a list or set of eligible counties, etc.

The process 400 includes accessing a data structure identifying a plurality of known mobile devices each associated with a set of features (block 404). The data structure may be a table or other data structure that includes a unique identifier for each of the known mobile devices (or for a set of similar mobile devices) and data indicative of a set of features or other data for the known mobile devices. For instance, the set of features can include one or more hardware features, one or more software features, an operating system type, an operating system version, a mobile carrier, a model name, a manufacturer, etc. The set of features of the data structure may be provided by one or more device manufacturers and/or retrieved from another database.

The process 400 includes generating a device filter (block 406). The generation of the device filter is based on a comparison of the set of required features to the associated set of features of the data structure for each of the set of known mobile devices of the data structure. In some implementations, the device filter includes a set of identifiers for one or more of the set of known mobile devices that are incompatible with the mobile application based on the comparison. That is, if the set features for each of the known mobile devices does not match or exceed those of the set of required features for the application, then the unique identifier for the known mobile device (or set of mobile devices) is added to the device filter (e.g., by adding a tuple of the application identifier and the device identifier). If the set features for a known mobile device does match or exceed those of the set of required features for the application, then the unique identifier for the known mobile device is not included in the device filter.

The device filters may include a set or list of tuples. The tuples can include a first unique identifier associated with an application and a second unique identifier identifying a corresponding known mobile device that is incompatible with the application, such as <AppinID, DeviceID>. In some instances, the tuples can further include a third unique identifier identifying a minimum operating system version for the application. In some instances, several known mobile devices can be associated with a single unique identifier when the several known mobile devices have similar features, similar operating system versions, etc. In some instances, each unique identifier identifying a corresponding known mobile device may be based on a device model, a device manufacturer, a device brand, and/or device features.

The process 400 further includes storing the generated device filter (block 408). The generated device filter can be stored in a device filter database, such as device filter database 160 of FIG. 3.

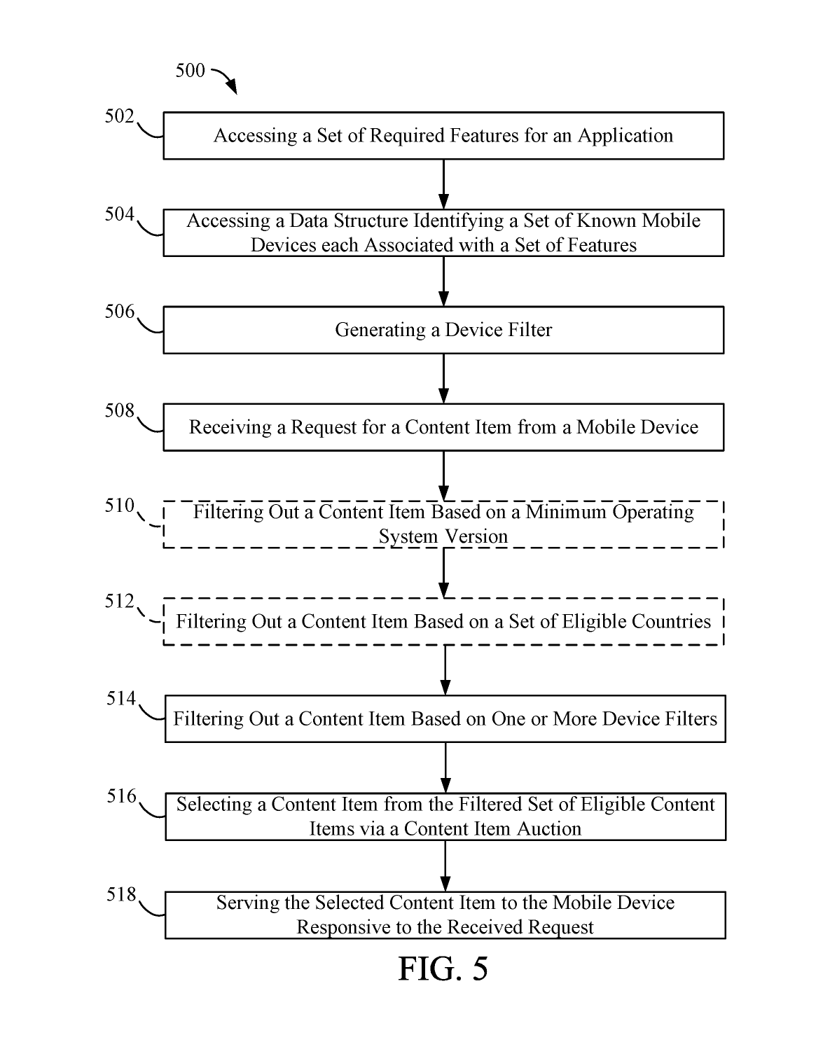

FIG. 5 depicts an example process 500 that may be implemented by the content item selection system to filter content items using a device-based filter. The process 500 includes accessing a set of required features for an application (block 502). The set of required features can be accessed from an application database. In some instances, the application database may be a local database or the application database may be a remote database relative to the content item selection system. In some instances, the application database may be an application store. In some implementations, the application store is controlled by a separate entity from the content item selection system performing a content item auction. The set of required features may be retrieved using an API to interact with the application store. In other implementations, the set of required features may be accessed via information from a landing page for the application of the application store. The set of required features may include one or more hardware features (e.g., a camera, a particular camera magnification level, near-field communication, etc.), one or more software features (e.g., other applications, plugins, etc.), an operating system type, a minimum operating system version, a list or set of eligible counties, etc.

The process 500 includes accessing a data structure identifying a plurality of known mobile devices each associated with a set of features (block 504). The data structure may be a table or other data structure that includes a unique identifier for each of the known mobile devices (or for a set of similar mobile devices) and data indicative of a set of features or other data for the known mobile devices. For instance, the set of features can include one or more hardware features, one or more software features, an operating system type, an operating system version, a mobile carrier, a model name, a manufacturer, etc. The set of features of the data structure may be provided by one or more device manufacturers and/or retrieved from another database.

The process 500 includes generating a device filter (block 506). The generation of the device filter is based on a comparison of the set of required features to the associated set of features of the data structure for each of the set of known mobile devices of the data structure. In some implementations, the device filter includes a set of identifiers for one or more of the set of known mobile devices that are incompatible with the mobile application based on the comparison. That is, if the set features for each of the known mobile devices does not match or exceed those of the set of required features for the application, then the unique identifier for the known mobile device (or set of mobile devices) is added to the device filter (e.g., by adding a tuple of the application identifier and the device identifier). If the set features for a known mobile device does match or exceed those of the set of required features for the application, then the unique identifier for the known mobile device is not included in the device filter.

The device filters may include a set or list of tuples. The tuples can include a first unique identifier associated with an application and a second unique identifier identifying a corresponding known mobile device that is incompatible with the application, such as <AppinID, DeviceID>. In some instances, the tuples can further include a third unique identifier identifying a minimum operating system version for the application. In some instances, several known mobile devices can be associated with a single unique identifier when the several known mobile devices have similar features, similar operating system versions, etc. In some instances, each unique identifier identifying a corresponding known mobile device may be based on a device model, a device manufacturer, a device brand, and/or device features.

In some implementations, the accessing of the set of required features (block 502), the accessing of the data structure (block 504) and the generation of the device filter (block 508) may be omitted and the process 500 may begin by accessing a generated device filter, such as by accessing the generated device filter stored in a device filter database.

The process 500 includes receiving a request for a content item from a mobile device (block 508). The request may include data identifying a set of device features or an identifier for the mobile device. The set of device features may include one or more hardware features, one or more software features, an operating system type, an operating system version, a mobile carrier, a model name, a manufacturer, etc. The identifier for the mobile device may include an IMEI, an ESN, a MEID, a device model, a manufacturer, and/or a brand.

The process 500 may include filtering out a content item associated with a mobile application based on a minimum operating system version (block 510). Filtering out the content item from a set of eligible content items is based on a comparison of the minimum operating system version of the set of required features to an operating system version of the set of device features or an operating system version associated with the identifier for the mobile device. In some implementations, a pre-generated minimum operating system version device filter may be retrieved and used to filter out content items for which the requesting mobile device is incompatible.

The process 500 may also include filtering out a content item based on a set of eligible countries (block 512). The filtering out of a content item based on the set of eligible countries is based on a comparison of a set of eligible countries (or, in some instances, a set of ineligible countries) for the mobile application to data identifying a location received from a requesting device and/or data identifying the mobile carrier for a requesting device. The data identifying the carrier can be indicative of a home location of the mobile device (e.g., Verizon® is indicative of a mobile device having a home location in the United States, O2 is indicative of a mobile device having a home location in the United Kingdom, etc.). The location data may be GPS data, obscured GPS data, Wireless Access Point data, etc.

The process 500 includes filtering out a content item based on one or more device filters (block 514). The filtering out of a content item based on one or more device filters is based on the generated device filter and the data identifying the set of device features or the identifier for the mobile device of the request. The identifier for the mobile device (e.g., an IMEI, an ESN, a MEID, etc.) can be used to determine a unique identifier for a known mobile device corresponding to the requesting device. In some instances, the identifier for the mobile device may correspond to a device model, manufacturer, and/or brand that may be used to determine the unique identifier for the corresponding known mobile device. In other implementations, a comparison of the data identifying the set of device features to a set of known devices from a device database may be performed to determine the unique identifier for the corresponding known mobile device. Once the unique identifier for the corresponding known mobile device is determined, the process 500 compares the unique identifier for the corresponding known mobile device to the identifiers of the device filter, such as the tuples, to determine a set of identifiers associated with applications which are incompatible with the known mobile device sending the request. A content item associated with an application can include data associating the content item with the application, such as metadata for the unique identifier of the associated application. The process 500 compares the set of eligible content items for the auction to the set of identifiers associated with incompatible applications and filters out one or more content items from the set of eligible content items based on the comparison.

The process 500 includes selecting a content item from the filtered set of eligible content items via the content item auction (block 516). The process 500 also includes serving the selected content item to the mobile device responsive to the received request (block 518). Data to display the selected content item is transmitted or served to the requesting device and/or a resource server via a network. The data can include graphical data, textual data, image data, audio data, video data, etc. that may be accessed from a database.

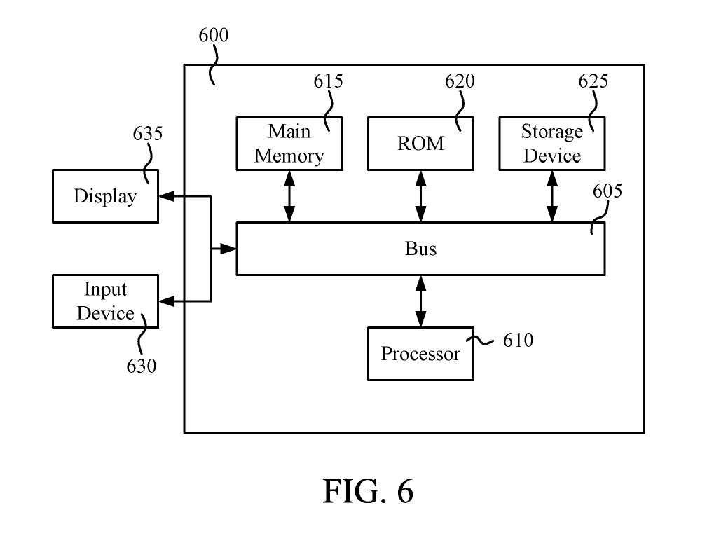

FIG. 6 is a block diagram of a computer system 600 that can be used to implement the client device 110, content item selection system 108, third-party content server 102, resource server 104, etc. The computing system 600 includes a bus 605 or other communication component for communicating information and a processor 610 coupled to the bus 605 for processing information. The computing system 600 can also include one or more processors 610 coupled to the bus for processing information. The computing system 600 also includes main memory 615, such as a RAM or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a ROM 620 or other static storage device coupled to the bus 605 for storing static information and instructions for the processor 610. A storage device 625, such as a solid state device, magnetic disk or optical disk, is coupled to the bus 605 for persistently storing information and instructions. Computing device 600 may include, but is not limited to, digital computers, such as laptops, desktops, workstations, personal digital assistants, servers, blade servers, mainframes, cellular telephones, smart phones, mobile computing devices (e.g., a notepad, e-reader, etc.) etc.

The computing system 600 may be coupled via the bus 605 to a display 635, such as a Liquid Crystal Display (LCD), Thin-Film-Transistor LCD (TFT), an Organic Light Emitting Diode (OLED) display, LED display, Electronic Paper display, Plasma Display Panel (PDP), and/or other display, etc., for displaying information to a user. An input device 630, such as a keyboard including alphanumeric and other keys, may be coupled to the bus 605 for communicating information and command selections to the processor 610. In another implementation, the input device 630 may be integrated with the display 635, such as in a touch screen display. The input device 630 can include a cursor control, such as a mouse, a trackball, or cursor direction keys, for communicating direction information and command selections to the processor 610 and for controlling cursor movement on the display 635.

According to various implementations, the processes and/or methods described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes and/or method steps described herein. One or more processors in a multi-processing arrangement may also be employed to execute the instructions contained in main memory 615. In alternative implementations, hard-wired circuitry may be used in place of or in combination with software instructions to effect illustrative implementations. Thus, implementations are not limited to any specific combination of hardware circuitry and software.

Although an implementation of a computing system 600 has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The terms “data processing apparatus,” “computing device,” or “processing circuit” encompass all kinds of apparatus, devices, and machines for processing data, including by way of example a programmable processor, a computer, a system on a chip, or multiple ones, a portion of a programmed processor, or combinations of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

References to “or” may be construed as inclusive so that any terms described using “or” may indicate any of a single, more than one, and all of the described terms.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

What is claimed is:

1. A method comprising:
accessing a set of required features for a mobile application;
accessing a data structure identifying a plurality of known mobile devices each associated with a set of features;
generating a device filter based on a comparison of the set of required features to the associated set of features of the data structure for each of the plurality of known mobile devices of the data structure, the device filter comprising a set of identifiers for one or more of the plurality of known mobile devices that are incompatible with the mobile application based on the comparison;
receiving a request for a content item from a mobile device, the request comprising data identifying a set of device features or an identifier for the mobile device;
filtering out a first content item associated with the mobile application from a set of eligible content items for a content item auction based on the generated device filter and the data identifying the set of device features or the identifier for the mobile device of the request;
selecting a second content item from the filtered set of eligible content items via the content item auction; and
serving the selected second content item to the mobile device responsive to the received request.

2. The method of claim 1, wherein the set of features for each of the plurality of known mobile devices comprises a model name, a manufacturer, and an operating system.

3. The method of claim 1, wherein the set of required features comprises a minimum operating system version, the method further comprising:
filtering out the first content item associated with the mobile application from the set of eligible content items based on a comparison of the minimum operating system version of the set of required features to an operating system version of the set of device features or an operating system version associated with the identifier for the mobile device.

4. The method of claim 1, wherein the first content item associated with the mobile application is filtered out from the set of eligible content items prior to the content item auction.

5. The method of claim 1, wherein the accessed set of required features for the mobile application is from an application store.

6. The method of claim 5, wherein the application store is controlled by a separate entity from an entity performing the content item auction.

7. The method of claim 1, wherein the request further comprises data identifying a location of the mobile device, the method further comprising:
accessing a set of eligible countries for the mobile application; and
filtering out a third content item associated with the mobile application from the set of eligible content items for the content item auction based on a comparison of the data identifying the location of the mobile device to the set of eligible countries.

8. The method of claim 1, wherein the generated device filter comprises a plurality of tuples, a set of the plurality of tuples comprising a first unique identifier identifying the mobile application, a second unique identifier identifying a corresponding one of the one or more of the plurality of known mobile devices that is incompatible with the mobile application, and a third unique identifier identifying an operating system version.

9. The method of claim 1, wherein the request further comprises data identifying a mobile carrier of the mobile device, the method further comprising:
accessing a set of eligible countries for the mobile application; and
filtering out a third content item associated with the mobile application from the set of eligible content items for the content item auction based on a comparison of the data identifying the mobile carrier of the mobile device to the set of eligible countries.

10. A system comprising:
one or more processors; and one or more storage devices storing instructions that, when executed by the one or more processors, cause the one or more processors to perform operations comprising:
accessing a set of required features for each of a set of mobile applications, the set of required features comprising a minimum operating system version;
accessing a data structure identifying a plurality of known mobile devices each associated with a set of features;
generating a device filter based on a comparison of the set of required features for each of the set of mobile applications to the associated set of features for each of the plurality of known mobile devices of the data structure, the device filter comprising a set of identifiers for one or more of the plurality of known mobile devices that are incompatible with one of the set of mobile applications;
receiving a request for a content item from a mobile device, the request comprising data identifying a set of device features or an identifier for the mobile device;
filtering out a first content item associated with a first mobile application of the set of mobile applications from a set of eligible content items for a content item auction based on a comparison of the minimum operating system version of the set of required features to an operating system version of the set of device features or an operating system version associated with the identifier for the mobile device;
filtering out a second content item associated with a second mobile application of the set of mobile applications from a remaining set of eligible content items for the content item auction based on the generated device filter and the data identifying the set of device features or the identifier for the mobile device of the request;
selecting a third content item from the filtered remaining set of eligible content items via the content item auction; and
serving the selected third content item to the mobile device responsive to the received request.

11. The system of claim 10, wherein the set of features for each of the plurality of known mobile devices comprises a model name, a manufacturer, and an operating system.

12. The system of claim 10, wherein the first content item associated with the mobile application is filtered out from the set of eligible content items prior to the content item auction.

13. The system of claim 10, wherein the accessed set of required features for the mobile application is from an application store.

14. The system of claim 13, wherein the application store is controlled by a separate entity from an entity performing the content item auction.

15. The system of claim 10, wherein the request further comprises data identifying a location of the mobile device, wherein the one or more storage devices stores instructions that, when executed by the one or more processors, cause the one or more processors to perform operations further comprising:
accessing a set of eligible countries for the mobile application; and
filtering out a fourth content item from the set of eligible content items for the content item auction based on a comparison of the data identifying the location of the mobile device to the set of eligible countries.

16. The system of claim 10, wherein the generated device filter comprises a plurality of tuples, a set of the plurality of tuples comprising a first unique identifier identifying the mobile application and a second unique identifier identifying a corresponding one of the one or more of the plurality of known mobile devices that is incompatible with the mobile application.

17. The system of claim 10, wherein the request further comprises data identifying a mobile carrier of the mobile device, wherein the one or more storage devices stores instructions that, when executed by the one or more processors, cause the one or more processors to perform operations further comprising:
accessing a set of eligible countries for the mobile application; and
filtering out a fourth content item from the set of eligible content items for the content item auction based on a comparison of the data identifying the mobile carrier of the mobile device to the set of eligible countries.

18. A computer readable storage device storing instructions that, when executed by one or more processors, cause the one or more processors to perform operations comprising:
accessing a set of required features from an application store for a mobile application;
accessing a data structure identifying a plurality of known mobile devices each associated with a set of features;
generating a device filter based on a comparison of the set of required features to the associated set of features of the data structure for each of the plurality of known mobile devices of the data structure, the device filter comprising a set of identifiers for one or more of the plurality of known mobile devices that are incompatible with the mobile application based on the comparison;
receiving a request for a content item from a mobile device, the request comprising data identifying a set of device features or an identifier for the mobile device;
filtering out a first content item associated with the mobile application from a set of eligible content items for a content item auction based on the generated device filter and the data identifying the set of device features or the identifier for the mobile device of the request;
selecting a second content item from the filtered set of eligible content items via the content item auction; and
serving the selected second content item to the mobile device responsive to the received request.

19. The computer readable storage device of claim 18, wherein the set of features for each of the plurality of known mobile devices comprises a model name, a manufacturer, and an operating system.

20. The computer readable storage device of claim 19, wherein the generated device filter comprises a plurality of tuples, a set of the plurality of tuples comprising a first unique identifier identifying the mobile application and a second unique identifier identifying a corresponding one of the one or more of the plurality of known mobile devices that is incompatible with the mobile application.
